(19) United States
(12) Patent Application Publication
(10) Pub. No.: US 2026/0305677 A1
(43) Pub. Date: Oct. 8, 2026

(54) NOVEL EXTRUDER

(71) Applicant: Texperience LTD, Tel Aviv (IL)

(72) Inventor: Moshe GOLDSTEIN, Netanya (IL)

(21) Appl. No.: 19/472,846

(22) PCT Filed: Apr. 17, 2024
(86) PCT No.: PCT/IL2024/050376

§ 371 Date: Oct. 6, 2025

Related U.S. Application Data
(60) Provisional application No. 63/459,875, filed on Apr. 17, 2023.

(51) Int. Cl. A23P 30/20; A23J 3/22; A23J 3/26

(52) U.S. Cl. CPC A23P 30/20; A23J 3/227; A23J 3/26

(57) ABSTRACT

The present invention relates to an advanced control and monitoring system for extrusion processes. The system enables in-line measurement of various parameters such as electrical conductivity, ultrasound conductivity, pressure, temperature, flow rate, viscosity, density, oxidation potential, modulus of elasticity, and other parameters relevant to food engineering (enabling objective measurement of output product quality), as well as back torque on the extrusion screw, extrusion speed, pressure, and so on. The system uses a melt pump for food extrusion and an ink-jet style injection for material feeding. The invention includes a feedback loop for process control, which uses vision, machine learning, and artificial intelligence to optimize the extrusion process based on quality of output and characteristics of input raw materials. The control and monitoring system uses an algorithm that employs machine learning, reinforcement learning, iteration, and extrapolation from previous closest input data.

### BACKGROUND OF THE INVENTION

The use of screw extruders is common across many industries, and is used for production of a wide variety of products including plastic and aluminum components as well as food products. In an extruder, materials able to undergo plastic deformation are forced through a die of a given cross section, with the material involved undergoing compressive and shear stresses. Multiple components can be mixed more or less homogenously in extruders, and multiple-screw extruders and other variants are known. As in many fields with long histories of use, numerous innovations have been introduced over the years in various subfields of extrusion. The extrusion process can be challenging, especially when working with materials that have complex properties, such as food products. Optimization of the extrusion process is in some cases accomplished using advanced control and monitoring systems that enable the measurement of critical parameters in real-time.

As an example, consider CN111055467A “Sheet extruder with melt pressure temperature control system”, which provides a sheet extruder with a melt pressure temperature control system having a plurality of heating temperature areas to implement a multi-zone temperature control system, a pressure sensor, a speed regulating mechanism, and a speed regulator. This device can automatically adjust and control the heating temperature of each heating temperature zone and the pressure of the plastic melt, so that the plastic melt is always kept in a useful range (e.g. allowing for constant speed operation). Similarly U.S. Pat. No. 9,981,416B1 “Extruder with static mixer injector” provides an apparatus for injection of fluid into an extruder that has a static mixer section leading to the extruder barrel, designed to simplify the fluid injection while giving more efficient absorption of thermal energy with a minimum of environmental contamination, and the ability to inject multiple streams into the extruder.

However as mentioned above certain advances from within various subfields of the extrusion industries have yet to be used in other subfields, and furthermore there are advances in control, algorithms, and injection mechanisms that have yet to be implemented at all in screw extruders. The present invention attempts to rectify this situation.

### SUMMARY OF THE INVENTION

The present invention provides a method and apparatus for improving extrusion processes. The invention includes a system for measuring a broadened range of parameters inside the extruder, including the standard set of temperature, pressure, and speed, and augmented by additional measurements including speed-of-sound, electrical conductivity, void fraction, moisture content, and more. Feedback and inputs from unconventional sources including measurements and images of the incoming raw material, material during processing, and product after processing, are also used as inputs to feedback loops that allow for the device to deal with wide variations in incoming raw material characteristics in real time.

The invention also includes the use of a controlled pressure device or melt pump at the end of the extruder to maintain stable back pressure and working conditions to the extrudate. The invention also provides for a needle-less injection system, similar to that employed by an ink-jet printer injector, to inject materials into the extruder process.

The invention addresses several issues. Firstly, this extruder separates and controls the extruder processes from the subsequent process of cooling of the extrudate (which in a preferred embodiment is a meat analog). Another aspect of the invention has to do with different ingredients requiring different cooking and extrusion conditions, which generally will require different die pressures and other optimal cooking and extrusion parameters. The inventive solution is to separate the extruder process from the cooling process using a controlled pressure device or melt pump. Separation and control of the extrusion process allows optimizing the cooking conditions, by controlling the cooling process with the right speed and other parameters needed for producing a particular extrudate. This process helps to purify and fine-tune the production of a variety of products.

Another issue concerns raw material variability. Extrusion machines often must work with raw materials coming from different sources, with inevitable variations in the various ingredients such as dry ingredients which are mixed with 60% to 70% water, depending on the moisture content of the ingredients. The innovative extruder takes into account variations in the raw materials by use of various measurements, and adjusts process parameters in real time (such as water content and other ingredient levels, as well as ‘regular’ process parameters including extrusion speed, temperature and pressure) to achieve consistent results despite inconsistent raw materials.

A further capability of the invention is its ability to produce a variety of homogenous and inhomogenous multi-texture and multi-flavor food products and to allow production of products suitable for a number of markets, including “food as medicine”. Some current extruders are adapted to produce products like chicken breast, and fish fillets, as homogeneous goods with some fraction of fibers. The solution involves injection of heterogenous components near the end of the extrusion process, allowing the addition of thermosensitive ingredients before final relaxation at the cooling chamber.

### BRIEF DESCRIPTION OF DRAWINGS

FIG. 1 shows an injector of the invention.

FIG. 2 shows the injector of the invention after injection of material into the extrudate, using the injector.

FIG. 3 shows the injector of the invention before injection into an extrudate having fiber layers.

FIG. 4 shows the injector of the invention after injection of material into an extrudate having fiber layers.

FIG. 5 shows the previous common method of working with a cooling die and optional individual quick freezer (IQF).

FIG. 6 adds the injector innovation of the invention to the process of FIG. 5, with pump and injection/insertion unit.

FIG. 7 adds the melt pump of the invention to the process of FIG. 6, with pump and injection/insertion unit.

FIG. 8 shows an extruder with a series of sensors.

FIG. 9 shows an extruder with sensors and the injector of the invention.

FIG. 10 shows a schematic of one implementation of the invention adapted for production of beef, chicken, or other meat substitutes adapted to produce a fat marbling effect.

### DEFINITIONS

The term “melt pump” refers to any controlled pressure device adapted to maintain a constant pressure in an extruder.

### DETAILED DESCRIPTION OF THE INVENTION

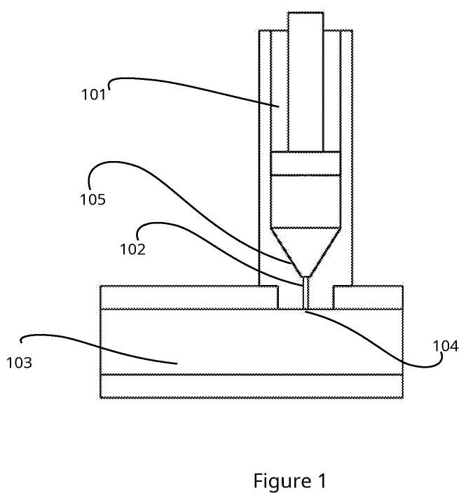

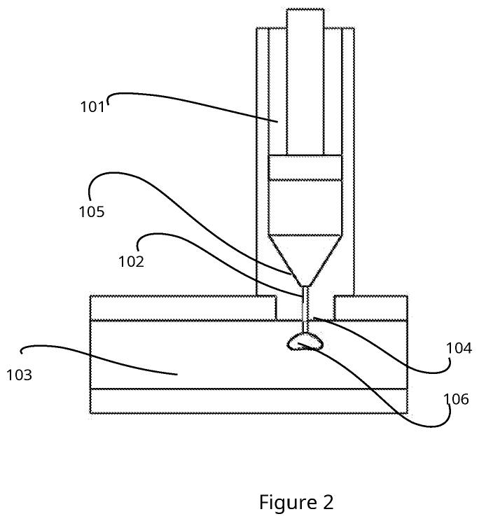

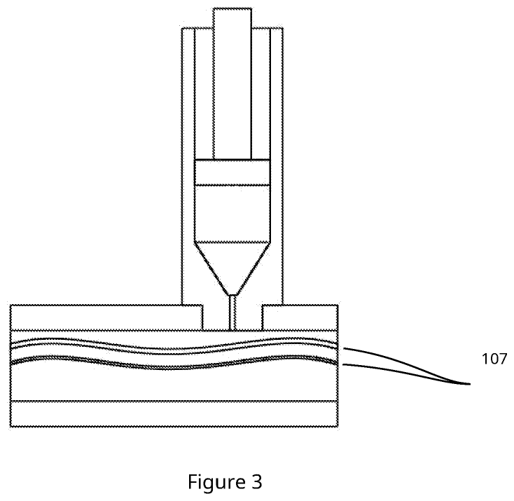

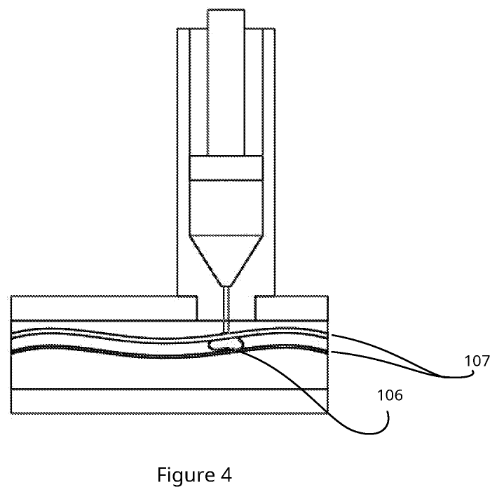

The present invention provides a method and apparatus for inline measurements, rapid cooking, and controlled extrusion in food extruders. The invention comprises a system for measuring parameters inside the extruder, such as temperature, pressure, speed-of-sound, electrical conductivity, void fraction, and moisture content, and includes sensors and probes adapted to make these measurements that are positioned at various points along the extruder. The measurements are transmitted to a central processing unit, which then adjusts the extruder parameters to maintain optimal extrusion conditions. Since many of the measurements being considered here (like acoustic or electrical conductivity) depend upon bulk properties (as opposed to point properties) they can provide information concerning not just the extrusion near the sensor but throughout the bulk of the extruded material. This difference can be important since it is generally the bulk properties that are of interest.
Feedback and inputs from unconventional sources including measurements and images of the incoming raw material, material during processing, and product after processing, are also used as inputs to feedback loops that allow for the device to deal with wide variations in incoming raw material characteristics. This allows for decreased waste due to production of unusable product. As a further example, in cases where the raw materials do not meet minimum standards, the production can be halted until this is rectified, again saving production cost that would otherwise go to waste. The invention also includes the use of a melt pump at the end of the extruder to maintain back pressure, as will be described later.
The system further includes a needle-less ink-jet style injector, which feeds material into the extrusion process immediately after the melt pump. This needle-less injection system includes a nozzle that can be adjusted to control the amount and placement of the injected material. The system includes a computer-controlled pump that delivers the material to the nozzle at a controlled rate. An example of such a device is shown in FIG. 1, where the main bore of the extruder 103 is provided with a hole 104 through which the jet 102 can be forced through nozzle 105. The nozzle 105 is connected to the main jet body 101 which forces the jet of material 102 through the nozzle 105 by means of electrostatic force, pressure, or other means as will be familiar to one skilled in the art. As will be appreciated, since the actual tip 105 of the device does not make contact with the extruded mass, it will not have to endure the wear which other injectors making physical contact would have to endure. FIG. 2 shows the same device after injection of an additive 106 into the extrudate. As shown in FIG. 2, due to the downstream position of the injector, the injected material can take an inhomogenous shape 106. This is useful for production of (for example) meat substitutes where an inhomogenous makeup is closer to the structure of actual meat. FIG. 3 shows the injector before injection into an extrudate having fiber layers 107, while FIG. 4 shows the injector of the invention after injection of material into an extrudate having fiber layers. This shows how the invention can mimic (for instance) irregularly located globules of fat substitute, blood substitute, or other components that allow for the final product to take a form very similar to that of real meat. The injector allows for production of a heterogenous extruded product, which will be closer in texture and ‘mouth-feel’ to real meat. For example red meat has regions of higher concentration of fat, blood, and muscle; in order to produce such a product even a triple-barrel extruder would only be able to produce a product with constant cross-section. The current invention on the other hand allows for a full three-dimensional heterogeneity such as that produced by a 3D printer, which is in fact used by some artificial meat producers. However since we achieve this heterogeneity in an extruder, far more material can be produced far more rapidly and cheaply, thus avoiding the bottlenecks of 3D printing at industrial scales.

The insertion head allows the device to be used for production of extruded materials suitable for a number of markets, including “food as medicine”. Instead of producing food products like chicken breast and fish filets, as largely homogeneous goods having some fraction of fibers, use of the injector allows injection of heterogenous components near the end of the extrusion process, allowing the addition of thermosensitive ingredients before final relaxation at the cooling chamber. As seen in FIG. 4 this allows for production of heterogenous products such as meat substitutes having distinct, irregular zones of different composition (for instance zones mimicking muscle, blood, and fat).

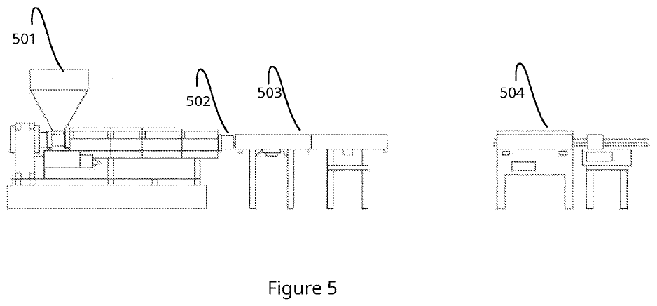

FIG. 5 shows the previous common method of working with a cooling die 503 and optional individual quick freezer (IQF) 504. The hopper 501 allows introduction of raw material into the system, and extruder head 502 has one or more built-in pressure transducers, as will be described below.

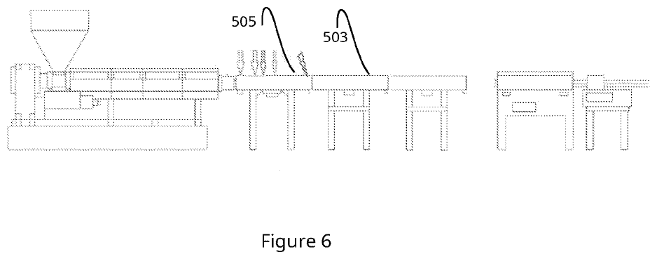

The system also introduces use of a melt pump between extrusion and cooling sections, which maintains back pressure and enables consistent flow rate of the extrudate. This is shown in FIG. 6 which adds the injector innovation 505 of the invention to the process of FIG. 5.

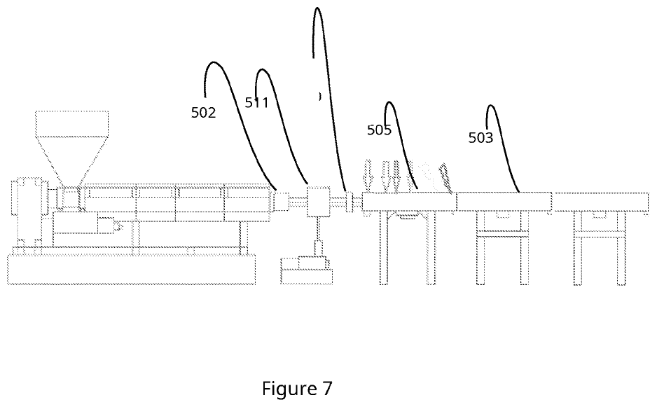

FIG. 7 adds a melt pump (aka gear pump) 511 to the process of FIG. 6, before the insertion unit 505. The gear pump 511 separates the extruder process from the cooling process of cooling die 503. This separation allows optimizing the cooking conditions, by controlling the cooling process with a known cooling rate, flow rate, and other parameters needed for producing a particular extrudate. Measurements necessary for this technique include pressure and possibly other transducers located at the extruder head 502 and post-gear transducers 510 located after the gear pump 511. This process helps to purify and fine-tune the production of a variety of products.

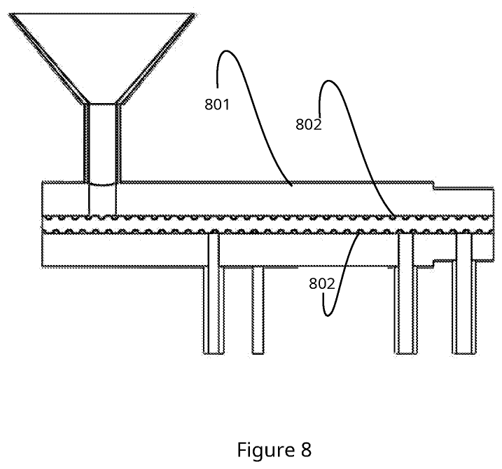

A further provision of the invention as shown in FIG. 8 is the extensive use sensors; here one sees an extrusion barrel 801 outfitted with a large series of sensors 802, allowing the process operator or algorithm a fine-grained understanding of the extrusion process.

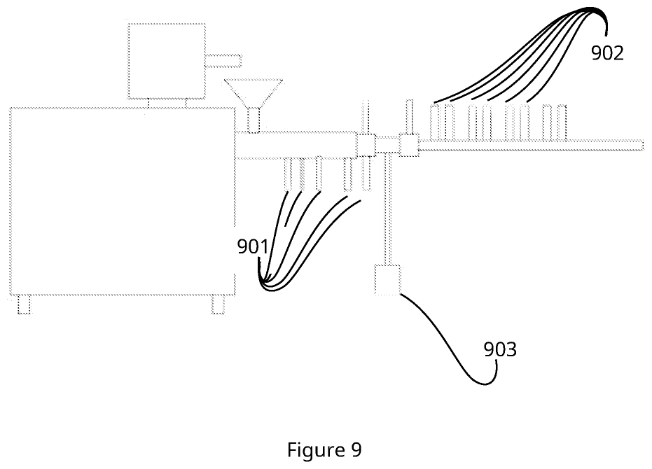

FIG. 9 shows another embodiment of the extruder, having a set of sensors 901 such as pressure sensors before the melt pump 903 (as mentioned in FIG. 7).

After the melt pump, a series of injectors 902 as described above may be used allowing for the independent injection of a large number of additives, allowing for a fine-grained control of the extrudate texture and composition.

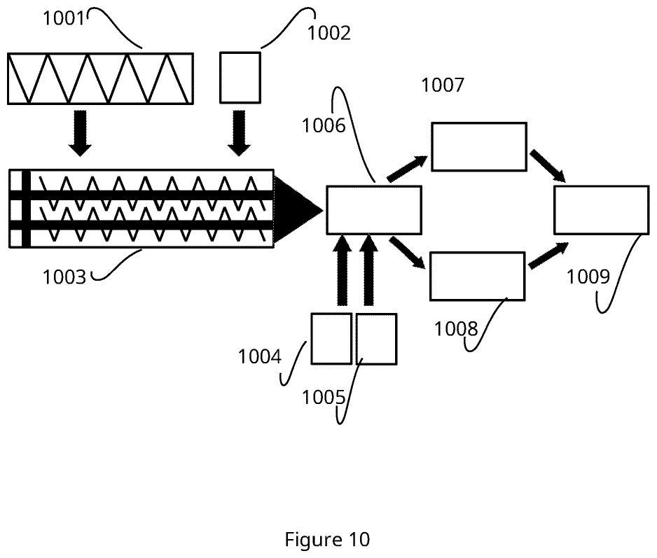

FIG. 10 shows another possible embodiment of the invention, specifically designed to produce meat substitute products having a close resemblance to animal meat. The twin-screw extruder 1003 is fed with input materials such as matrices of protein and/or polysaccarides 1001, and water 1002. These ingredients are extruded into a long cooling die 1006 where such elements as fat 1004 and collagen 1005 are added, and further ingredients added in additional split extrusion line segments 1007 and 1008. These individual lines can then be recombined at section 1009 where the final product is output

A key provision of the invention is for use of feedback and inputs from sources including but not limited to still images, video, and measurements of a wide variety of parameters. These measurements of the incoming raw material, material during processing, and product after processing, are also used as inputs to feedback loops that allow for the device to deal with wide variations in incoming raw material characteristics, improving the output quality and decreasing waste. The system enables objective measurement of output product quality, including temperature, pressure, viscosity, chemical composition, void fraction, density, oxidation potential, modulus of elasticity, and other parameters relevant to food engineering as well as electrical conductivity, ultrasound conductivity, flow rate, and back torque on the extrusion screw, among others. The system enables objective measurement of the output product quality visually, chemically, and physically, which is used to optimize the extrusion process.

As mentioned above, the invention also includes the use of a melt pump after the extruder (and, for example, before the cooling die) to maintain back pressure. The melt pump is a controlled pressure device which is located after the extrusion barrel, and is designed to keep the material at a consistent pressure to ensure consistent extrusion. This melt pump allows the extrusion parameters (such as extrusion speed and die size) to be decoupled from the process pressure; without such a melt pump, the process pressure is determined entirely by such parameters as the extrusion speed, die size (smaller dies leading generally to higher pressures), and extrudate viscosity. By allowing for pressure control without regard to the other process parameters, the process parameters may be freely varied without affecting the pressure. This allows greater latitude in control of the device.

The use of the melt pump allows quick ‘pressure cooking’ of the extrudate. This results from extreme cooking conditions combined with short residence times for the extrudate in the extruder, allowing for rapid cooking without reducing the quality of product and allowing for rapid production in optimal conditions.

This advancement allows the possibility to accelerate cooking in the extruder. Cooking parameters can be modified, using the preferred parameters to get the dough to an optimal cooking point. This will help to produce different whole cuts to imitate the texture and bite of whole cuts, including meat fillet and fish fillet.

It is within provision of the invention to employ a decreased length of extruder, adapted for a faster extrusion process occurring at a higher temperature than standard extruders. A smaller than usual nozzle at the end of the cooling die may be used in some cases, for increasing the pressure of the process.

The invention further allows for control of the relaxation time of the extruded material while travelling through the cooling die.

Adding taste ingredients to the dough while it travels through the inserting head and the cooling die, enables imitating tastes of different food types, flavors, and textures. These ingredients may be added in a heterogeneous fashion which will aid in the production of artificial meats, which generally have a heterogeneous texture comprising muscle, blood, and fat in different concentrations in various regions.

As mentioned, parameters of both input raw materials, material in process, and output may be collected and used for each production batch in order to accurately predict and monitor the outcome and tailor the product to different requirements. The control and monitoring system employs an algorithm that enables optimization of the extrusion process based on the quality of the output and the characteristics of the input raw materials. The algorithm uses algorithms adapted for this purpose, involves for example machine learning, reinforcement learning, iteration, and extrapolation from previous closest input data. The system also includes a feedback loop that uses vision, machine learning, and artificial intelligence to optimize the extrusion process.

Algorithms adapted for this purpose change the process parameters based on the quality of the output, the characteristics of the input raw materials, and measurements of the extrudate being worked. Thus the process parameters can be adjusted based on the internal process parameters measured in real-time, pressure, temperature, back torque on the extrusion screw, and flow rate as well as characteristics of the incoming raw materials (water content and any of the aforementioned measurements) and characteristics of the final product (including visual appearance, taste as reported by manual or automated means, and again any of the aforementioned measurements of electrical conductivity, etc). A manual taste test may be employed in order to get ground-truth feedback from human tasters, for instance after every change to the production parameters. The taste test may also be a blind test whereby tasters try both real and artificial meat as produced by the inventive system, and try to identify which samples are artificial and which are real meat. This feedback will allow a quantitative measure of how realistic the product is, thus enabling the system operator (or AI system) to change parameters in an attempt to improve performance on this test.

The sensors of the device are in part designed to obtain data regarding density, thickness, flexibility, viscosity, ‘rubberiness’, and other measures of texture for tailoring of the product. It is also an object of the invention to provide for measurement of ‘bulk’ properties of the extrudate and not just ‘surface properties’. By this we mean that measurements taken of the extrudate in conventional extruders tend to measure the properties at the outer surface of the extrudate, where it contacts the extruder barrel surface. Thus the properties of the bulk of the extrudate are not directly measured in common practice. In order to rectify this situation a number of non-contact measurements may be used in the innovative extruder including measurements of electrical conductivity (including impedance spectroscopy and impedance imaging), sound conductivity (including ultrasound measurement such as ultrasound imaging), void fraction, and measures of homogeneity, liquid fraction, water fraction, and soluble component fraction.

Measurements adapted to determine composition, texture, friability, viscosity, taste, and smell are all within provision of the invention. Such analyses may be carried out by mass spectrometry, gas chromatography, GC-TOF-MS, ‘electronic nose’, and any other method suitable for these determinations.

Process parameters can also be adjusted in multiple zones, e.g. where more ‘fat’ or more ‘meat’ is required. These adjustments may be accomplished using any useful algorithm taken from the fields of machine learning, reinforcement learning, iteration, and extrapolation from previous closest input data.

It is within provision of the invention to include a ‘shaping mold’ which may be (for instance) a two-part mold used to stamp the extrudate as it passes out of the final section of the extruder, in the manner of a stamping unit as used for production of corrugated plastic pipe. In this manner, different shapes such as cutlets, shrimp, filets, tenders, nuggets and so on may be formed in a continuous (as opposed to batch) operation. Multiple molds may be employed for creation of more complex shapes, and/or to allow any of a variety of shapes to be produced from a given extruder line.

Finally, the invention includes the transfer of knowledge from the world of plastic extruders to that of food extruders. The transfer of knowledge includes the use of materials, designs, and processes from the plastic or metal extrusion processes that have been found to be effective and transferring these to the food extrusion process. This allows for the creation of more efficient and effective extruders. Likewise it may be found of use to take domain knowledge from food extrusion and use these materials, designs, and processes in fields of plastic extrusion.

1. An extruder through which, when in operation, input material flows from an upstream input end toward a downstream output end, the extruder comprising:
a. an extrusion cylinder defining an upstream portion of a main bore through which the input material flows as extrudate, and containing one or more extrusion screws;
b. a gear pump downstream of said extrusion cylinder, adapted to maintain back pressure upon said extrudate at locations within the extrusion cylinder upstream of said gear pump;
wherein said gear pump is configured to control said back pressure upon said upstream extrudate in accordance with one or more measurements from long the extruder.

2. The extruder of claim 1 further comprising a needle-less injection system adapted to insert additional materials into said extrudate at controllable depths within said extrudate, said needle-less system comprising:
a. a jet injector with adjustable nozzle positioned outside of the main bore, and configured to produce a jet of material under pressure; and
a. a hole leading laterally into a downstream portion of the main bore at a position downstream of the gear pump, into which said hole the nozzle directs the jet of material;
whereby a controllable amount and depth of jet-injected material is provided within the extrudate.

3. The extruder of claim 1, further comprising a bulk measurement sensor selected from the group consisting of: acoustic conductivity sensor, ultrasound imaging sensor, electrical impedance sensor, impedance imaging sensor, and impedance spectroscopy sensor.

4. The extruder of claim 1, adapted to control parameters of said extruder including pressure, temperature, speed, water content, and incoming material feed rates in accordance with measurements of the operation of said extruder.

5. The extruder of claim 4, configured use parameters of the incoming input material to control said parameters of said extruder in accordance with the feedback measurements of the operation of said extruder.

6. The extruder of claim 5, configured to use parameters of said extrudate within said extrusion cylinder to control said parameters of said extruder in accordance with the feedback measurements of the operation of said extruder.

7. The extruder of claim 6, configured to use parameters of outgoing product to control said parameters of said extruder in accordance with the feedback measurements of the operation of said extruder.

8. The extruder of claim 1 wherein cooking of said upstream extrudate is accelerated by the back pressure maintained by said gear pump.

9. The extruder of claim 1 further comprising a cooling die downstream of said gear pump.

10. A method for extrusion of meat substitutes comprising:
a. providing an extrusion cylinder defining an upstream portion of a main bore containing extrudate and one or more extrusion screws, and through which the extrudate flows from an upstream input end toward a downstream output end;
b. maintaining back pressure upon said extrudate using a gear pump located downstream of said extrusion cylinder;
wherein said gear pump is operated to control said back pressure upon said upstream extrudate in accordance with one or more measurements from along the extruder.

11. The method of claim 10, comprising injecting additional materials into said extrudate by needle-less injection at depths within said extrudate controlled by adjustment of a jet of material provided from an adjustable nozzle and directed to enter a hole leading laterally into said extrusion cylinder, whereby a controllable amount and depth of inject material is provided within the extrudate.

12. The method of claim 10, further comprising measuring one or more parameters of the extrusion process selected from the group consisting of: acoustic conductivity, ultrasound imaging, electrical impedance, impedance imaging, and impedance spectroscopy.

13. The method of claim 10, comprising controlling parameters of said extruder including pressure, temperature, speed, water content, and incoming material feed rates in accordance with feedback measurements of the operation of said extruder.

14. The method of claim 13 wherein said controlling uses parameters of raw material incoming into said extruder.

15. The method of claim 14 wherein said controlling uses parameters of said extrudate within said extrusion cylinder.

16. The method of claim 15 wherein said controlling uses parameters of outgoing product.

17. The method of claim 10, comprising cooking said upstream extrudate at an elevated temperature selected in accordance with the back pressure maintained by said gear pump.

18. The method of claim 10, further comprising cooling said extrudate within a cooling die located downstream of said gear pump.
